(19) United States
(12) Patent Application Publication
(10) Pub. No.: US 2007/0260634 A1
(43) Pub. Date: Nov. 8, 2007

(54) APPARATUS, SYSTEM, METHOD, AND COMPUTER PROGRAM PRODUCT FOR SYNCHRONIZING THE PRESENTATION OF MEDIA CONTENT

(75) Inventors: Kaj Makela, Tampere (FI); Ali Ahmaniemi, Tampere (FI); Timo T. Koskinen, Toijala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/381,600

(22) Filed: May 4, 2006

(51) Int. Cl. G06F 17/00

(52) U.S. Cl. 707/104.1

(57) ABSTRACT

A system, media device, method and computer program product are provided that synchronize the presentation of a secondary media content to the presentation of a primary media content. As the primary media content is presented, one or more feature vectors are extracted from the primary media content. The extracted feature vectors are compared to plurality of feature vectors that were previously extracted from the primary media content to determine which of the previously extracted feature vector matches the extracted feature vector. Each of the plurality of previously extracted feature vectors is associated with a timestamp corresponding to the temporal location of each feature vector within the primary media content. The start time for the secondary media content may then be set based on the timestamp of the matching previously extracted feature vector, and the presentation of the secondary media content may begin at the determined start time.

### FIELD OF THE INVENTION

Exemplary embodiments of the invention generally relate to systems and methods of presenting media content and, more particularly, relate to systems, devices, methods, and computer program products for synchronizing the presentation of media content.

### BACKGROUND OF THE INVENTION

Media content may comprise visual content, such as video and/or still pictures. Media content may additionally or alternatively comprise audio content, such as songs and/or dialog. Generally, media content comprises any visual and/or audio information capable of being presented to a user. Media content may be presented to a user via a media device, such as a media player. For purposes of this application, the term “media device” will be used to refer to all devices capable of presenting visual and/or audio media content to a user, whether the device is a television, personal computer, a mobile telephone, an MP3 player (or a player capable of playing other audio formats), a personal digital assistant (PDA), or any other type of device, whether mobile or not, whether connected to a network or not, and if connected to a network, whether the network is the Internet, a cable television network, a satellite network, a mobile telephone network, a proximity network (e.g., Bluetooth), or any other type of network, and whether the communication with the network is wired or wireless. Such media devices may receive media content from a media source, such as a media server. The media content may be transmitted in its entirety to the media device, or otherwise transferred to the media device (e.g., via a CD, DVD, memory stick, or any other suitable portable memory device). The media content may be stored in memory on the media device and presented (“played”) to the user from memory. Alternatively, the media content may be “streamed” from the media server (or other media source) to the media device via a network, such that the media content is presented to the user as the content is arriving at the media device.

A great deal of media content is available for users. However, even with the large amount available, there are many situations in which standard media content is not adequate for a particular user. For example, a user may desire to view a movie, but the dialog of the movie may be in a language that the user does not understand. Similarly, a user who is hearing-impaired may not be able to hear the dialog of a movie. A user may desire to view and/or listen to additional, supporting media content (which may be termed “secondary media content”) which expands on the original content (which may be termed “primary media content”). Such secondary content may include, for example, the director's commentary regarding the original content, a friend's personal commentary regarding the original content, subtitling for hearing-impaired users, audio dubbing in a different language from the original, subtitling of song lyrics to enable the user to sing along, “pop-up fact boxes” containing additional information, and the like.

Existing services currently enable searching and downloading of secondary content, such as subtitles for films. However, the presentation of secondary media content must be carefully synchronized to the presentation of the primary media content. This is particularly true when the secondary media content comprises dubbed dialog, as a mismatch between the dubbed dialog and the on-screen actions may be quite distracting to the user. Unfortunately, current methods of synchronizing primary and secondary media content can be difficult to implement, and typically require the use of a synchronization signal, such as a timecode or other marker, incorporated into the primary media content.

As such, there is a need for a method of quickly and easily synchronizing the presentation of secondary media content to the presentation of primary media content.

### BRIEF SUMMARY OF THE INVENTION

A system, media device, method and computer program product are provided that synchronize the presentation of a secondary media content to the presentation of a primary media content. As the primary media content is presented, one or more feature vectors are extracted from the primary media content. The primary media content may be presented on the media device or on a separate device and captured by the media device using a camera and/or microphone. The extracted feature vectors are compared to a plurality of feature vectors that were previously extracted from the primary media content to determine which of the previously extracted feature vector matches the extracted feature vector. Each of the plurality of previously extracted feature vectors is associated with a timestamp corresponding to the temporal location of each feature vector within the primary media content. The start time for the secondary media content may then be set based on the timestamp of the matching previously extracted feature vector, and the presentation of the secondary media content may begin at the determined start time.

In one exemplary embodiment, an apparatus for synchronizing the presentation of media content comprises a processing element configured to extract a feature vector from a primary media content as the primary media content is presented. The processing element may be further configured to compare the extracted feature vector to a plurality of stored feature vectors in the storage element, the stored feature vectors previously extracted from the primary media content, and each of the stored feature vectors having a respective timestamp corresponding to a temporal location of the stored feature vector within the primary media content. The processing element may be further configured to determine which of the stored feature vectors matches the extracted feature vector; and the processing element further configured to set a start time for a secondary media content based on the timestamp of the stored feature vector that matches the extracted feature vector. The processing element may be further configured to begin a presentation of the secondary media content at the start time.

The processing element may be further configured to determine a first time at which the feature vector was extracted and determining a second time at which the start time is to be set; and wherein the processing element sets the start time further based on a difference between the first time and the second time.

The processing element may be further configured to extract a plurality of feature vectors from the primary media content as the primary media content is presented, each of the feature vectors extracted a predefined period of time after the preceding feature vector was extracted. As such, the processing element may be further configured to compare the extracted plurality of feature vectors to the plurality of stored feature vectors and determine which of the stored feature vectors match the plurality of extracted feature vectors, and wherein the processing element sets the start time based on the timestamp of the stored feature vector that matches the temporally-first extracted feature vector.

The extracted feature vector may be a first feature vector of a first type and the plurality of stored feature vectors may be a first plurality of stored feature vectors of the first type. The processing element may be further configured to extract a second feature vector of a second type from the primary media content as the primary media content is presented. The processing element may be further configured to compare the second extracted feature vector to a second plurality of stored feature vectors of the second type, the stored second feature vectors previously extracted from the primary media content, and each of the stored second feature vectors having a respective timestamp corresponding to a temporal location of the stored feature vector within the primary media content. The processing element may be further configured to determine which of the stored second feature vectors matches the extracted second feature vector and has the same timestamp as the stored first feature vector that matches the extracted first feature vector.

The apparatus may be embodied in a media player, and the primary media content and the secondary media content may be stored in a storage element of the media player. Alternatively, the processing element may be configured to capture the primary media content via at least one of a camera or a microphone as the primary media content is presented. In another alternative embodiment, the apparatus may be embodied in a media server, and the primary media content and the secondary media content may be streamed across a network from the media server to a media player.

In another exemplary embodiment, an apparatus for synchronizing the presentation of media content comprises a processing element configured to extract a feature vector from a primary media content as the primary media content is presented. The processing element may be further configured to provide the extracted feature vector for transmission to a media server configured to compare the extracted feature vector to a plurality of stored feature vectors and determine which of the stored feature vectors matches the extracted feature vector, the stored feature vectors being previously extracted from the primary media content, and each of the stored feature vectors having a respective timestamp corresponding to a temporal location of the stored feature vector within the primary media content.

The processing element may be further configured to receive a timestamp of the stored feature vector that matches the extracted feature vector from the media server, and further configured to set a start time for a secondary media content based on the received timestamp. The processing element may be further configured to begin a presentation of the secondary media content at the start time.

The processing element may be further configured to determine a first time at which the feature vector was extracted and determine a second time at which the start time is to be set, such that the processing element sets the start time further based on a difference between the first time and the second time.

The processing element may be further configured to extract a plurality of feature vectors from the primary media content as the primary media content is presented, each of the feature vectors extracted a predefined period of time after the preceding feature vector was extracted. The processing element may be further configured to transmit the plurality of feature vectors to a media server configured to compare the extracted plurality of feature vectors to the plurality of stored feature vectors and determine which of the stored feature vectors match the plurality of extracted feature vectors. The processing element may be further configured to receive a timestamp of the stored feature vector that matches the temporally-first extracted feature vector from the media server, and to set the start time based on the received timestamp.

The extracted feature vector may be a first feature vector of a first type, and the plurality of stored feature vectors may be a first plurality of stored feature vectors of the first type. The processing element may be further configured to extract a second feature vector of a second type from the primary media content as the primary media content is presented. The processing element may be further configured to transmit the second feature vector of a second type to a media server configured to compare the second extracted feature vector to a second plurality of stored feature vectors of the second type, the stored second feature vectors being previously extracted from the primary media content, and each of the stored second feature vectors having a respective timestamp corresponding to a temporal location of the stored feature vector within the primary media content. The processing element may be further configured to receive a timestamp of the stored second feature vectors that matches the extracted second feature vector and of the stored first feature vector that matches the extracted first feature vector.

The apparatus may be embodied in a media player, such that the primary media content and the secondary media content are stored in a storage element of the media player.

In addition to the apparatus for synchronizing the presentation of media content described above, other aspects of embodiments of the invention are directed to corresponding systems, methods and computer program products for synchronizing the presentation of media content.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system for synchronizing the presentation of media content, in accordance with embodiments of the invention;

FIG. 2 is a flowchart of the operation of synchronizing the presentation of media content, in accordance with an exemplary embodiment of the invention; and

FIG. 3 is a graphical illustration of matching extracted feature vectors to previously extracted feature vectors, in accordance with alternative embodiments of the invention.

### DETAILED DESCRIPTION OF THE INVENTION

Exemplary embodiments of the invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

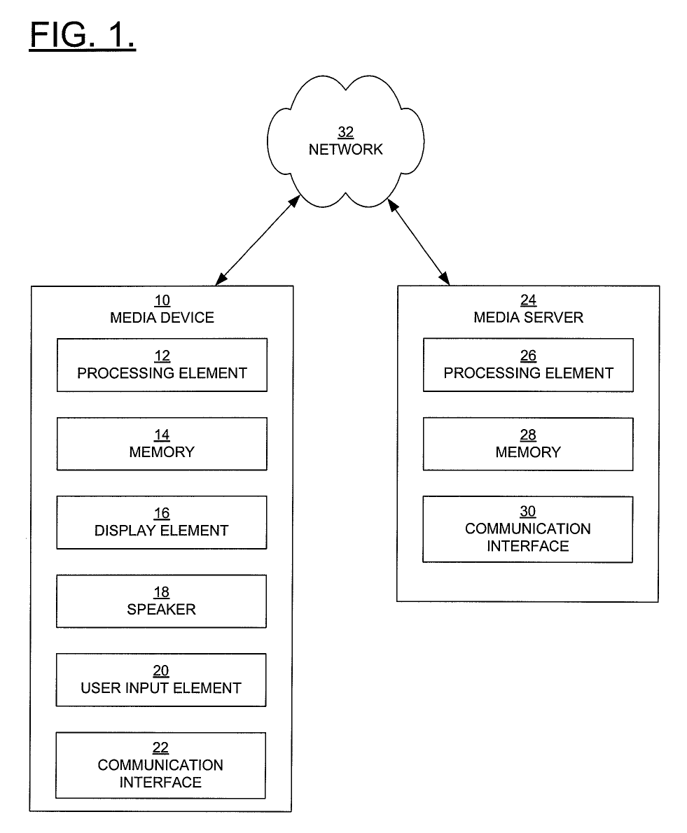

Referring now to FIG. 1, a block diagram of a system for synchronizing the presentation of media content is shown, in accordance with one embodiment of the invention. The system may comprise a media player, such as media device 10, and a media source, such as media server 24, in communication over a network 32. The media device 10 of FIG. 1 may be any device capable of presenting media content to a user, whether the device is television, personal computer, a mobile telephone, an MP3 player (or a player capable of playing other audio formats), a PDA, or any other type of device. As shown, the entity capable of operating as a media device 10 generally includes a processing element 12 capable of executing a media presentation application, as well as a media synchronization application in accordance with embodiments of the invention. While the processor can be configured in various manners, the processor may be comprised of a microprocessor, controller, dedicated or general purpose electronic circuitry, a suitably programmed computing device, or other means for executing a gaming application.

Processing element 12 may be connected to or otherwise capable of accessing a memory 14. The memory can comprise volatile and/or non-volatile memory or other storage means, and typically stores content, applications, data, or the like. For example, the memory typically stores media content (primary media content and/or secondary media content) received by the media device (although, as discussed below, media content may be streamed to the media device such that the media content may be presented to the user without storing the media content on the media device, or primary media content may be presented by a separate device and captured by the media device using, e.g., a camera and/or a microphone). In one embodiment, the secondary media content may be a “drive list” that refers to several different files stored on the media device or available on a network resource. Such a drive list would typically comprise a list of separate files, each of which is designed to be presented to the user at a particular point in the presentation of the primary media content. Therefore, the secondary media content can be, e.g., a timed playlist referring to multiple different files. In other exemplary embodiments, the secondary media content may be a Java applet, a Flash application, an Asynchronous JavaScript and XML (ajax) application, or any other suitable application capable of being synchronized with a primary media content. As discussed below, the memory may also store previously extracted feature vectors corresponding to a primary media content to enable the synchronization of secondary media content to the primary media content, in accordance with exemplary embodiments of the invention.

In addition to the memory 14, the processing element 12 may also be connected to at least one interface or other means for transmitting and/or receiving data, media content or the like. In this regard, the interface(s) can include at least one communication interface 22 or other means for transmitting and/or receiving data. The communication interface 22 may communicate with and receive data from external devices, such as media server 24, using any known communication technique, whether wired or wireless, including but not limited to serial, universal serial bus (USB), Ethernet, Bluetooth, wireless Ethernet (i.e., WiFi), cellular, infrared, and general packet radio service (GPRS). The communication interface 22 may enable the media device to communicate via a network 32, which may be the Internet, a mobile telephone network, or any other suitable communication network.

The processing element may also be connected to at least one user interface that may include a display element 16, a speaker 18, and/or a user input element 20. The user input element, in turn, may comprise any of a number of devices allowing the media device to receive data and/or commands from a user, such as a keypad, a touch display, a joystick or other input device. The user input element may also comprise a microphone and a camera, especially if the media device is a mobile telephone.

As shown, the entity capable of operating as a media server 24 generally includes a processing element 26 capable of executing a media sourcing application, as well as a media synchronization application in accordance with embodiments of the invention. The media server 24 may provide media content to the media device 10, typically upon request by a user of the media device. The media server may transmit media files comprising media content to the media device, which the media device may store for future presentation to the user. Alternatively, the media server may stream media content to the media device such that the media content may be presented to the user as the media content is being received by the media device, without storing the media content on the media device.

Processing element 26 of the media server may be connected to or otherwise capable of accessing a memory 28. The memory can comprise volatile and/or non-volatile memory or other storage means, and typically stores content, applications, data, or the like. For example, the memory typically stores media content (primary media content and/or secondary media content) to be transmitted or streamed to the media device. As discussed below, the memory 28 may also store previously extracted feature vectors corresponding to a primary media content to enable the synchronization of secondary media content to the primary media content, in accordance with exemplary embodiments of the invention.

In addition to the memory 28, the processing element 26 may also be connected to at least one interface or other means for transmitting and/or receiving data, media content or the like. In this regard, the interface(s) can include at least one communication interface 30 or other means for transmitting and/or receiving data. The communication interface 30 may communicate with and receive data from external devices, such as media device 10, using any known communication technique, whether wired or wireless, including but not limited to serial, universal serial bus (USB), Ethernet, Bluetooth, wireless Ethernet (i.e., WiFi), cellular, infrared, and general packet radio service (GPRS). The communication interface 30 may enable the media server to communicate via network 32.

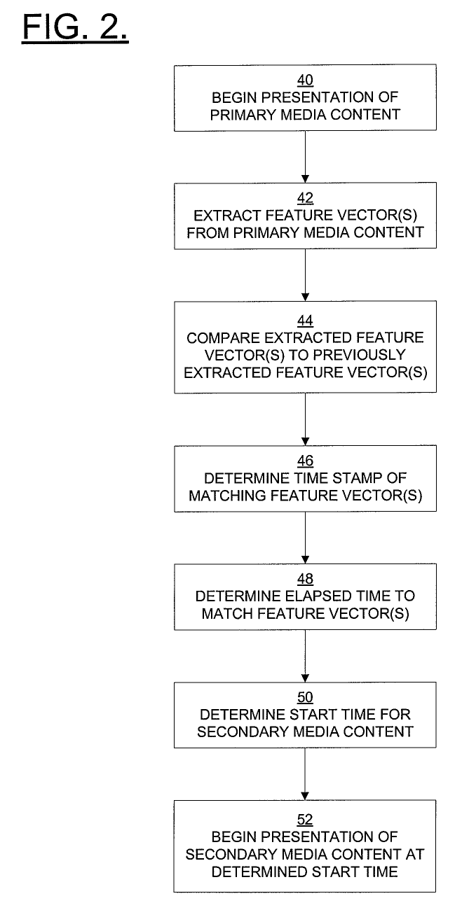

Referring now to FIG. 2, a flowchart of the operation of synchronizing the presentation of media content is illustrated, in accordance with one exemplary embodiment of the invention. FIG. 2 generally illustrates actions that may occur during the operation of synchronizing media content, although the entity in which these actions occur may vary in accordance with different embodiments of the invention. For example, the described actions may occur entirely in the media device, may occur entirely in the media server, or may occur partly in the media device and partly in the media server. The actions illustrated in FIG. 2 will first be generally described, irrespective of the entity in which the actions occur, and then specific exemplary embodiments will be described with particular regard to the entity in which each action may occur.

The synchronization of a secondary media content, such as dubbed dialog, to a primary media content, such as a movie, typically begins by starting the presentation of the primary media content. See block 40. The primary media content may be presented from the memory of a media device or may be streamed to the media device from a media server. Alternatively, the primary media content may be presented by a separate device, such as a television (including interactive television), a movie projector projecting a movie upon a screen, a song or other audio playing from a stereo system, or an electronic game playing on, e.g., a PC or a gaming system. Such a separately presented primary media content may be captured during presentation, such as by a camera and/or microphone. The camera and/or microphone used for capturing audio samples, images or video for feature vector extraction may be integral to the media player. Alternatively, the camera and/or microphone may be separate from but in communication with the media player. For example, the camera and/or microphone may be in communication with the media player via a wireless communication method such as Bluetooth. In such an exemplary alternative embodiment in which the primary media content is present by a separate device, the media device may be positioned relative to the television or movie screen to enable the primary media content presented on the television or movie screen to be captured by the media device. As described in detail below, the media device may then extract the feature vectors from the captured primary media content to synchronize the secondary media content with the primary media content being displayed upon the television or movie screen.

As the primary media content is presented (and as the audio and/or video is captured using a microphone and/or camera, in the case of a separately presented primary media content), one or more feature vectors are extracted from the primary media content. See block 42. Feature vectors are numeric values representing characteristics of an object, and are typically used in pattern recognition applications. Many different types of feature vectors may be used, such as video brightness, audio volume, peak audio frequency, color value (e.g., the color value at one physical point on the display screen or the average color value over the entire display screen), and any other suitable feature vector. Typically, a plurality of the same type of feature vector will be extracted over a predefined sampling period and at predefined time intervals. For example, the video brightness of the primary media content may be extracted once every 50 milliseconds over a two second sampling period (resulting in 40 extracted brightness values). A feature vector may refer to one or more parameters identified at each instance in time.

The feature vectors will typically be extracted from a sampling period which occurs early in the presentation of the primary media content, to enable the secondary media content to be presented during most of the presentation of the primary media content. However, the sampling period may need to be selected carefully to ensure that mostly non-zero values are extracted. For example, the beginning of a movie may contain several seconds of blank (i.e., dark or black) video frames, which would result in all zero brightness values if the brightness feature vector were extracted during a sampling period that corresponded with the blank video frames. As such, it would be undesirable to extract any image-related feature vectors while blank video frames are presented. Similarly, it would be undesirable to extract any audio-related feature vectors during silent periods of the primary media content. After the feature vectors are extracted over a selected sampling period, the number of zero values in the extracted feature vectors may be determined. If the percentage of zero values in relation to all extracted values exceeds a predefined threshold (e.g., 75%), the extracted values may be discarded and the feature vectors may be re-extracted over a different period of time to ensure an adequate percentage of non-zero values in order to accurately match the extracted feature vectors to the previously extracted feature vectors (as described below).

The predefined time intervals (50 milliseconds in the above example) may vary depending on how precisely the secondary media content is to be synchronized to the primary media content. For example, secondary media content that provides subtitling typically requires less precise synchronization than secondary media content that provides dubbed dialog, as a user is more likely to notice and be distracted by imprecise synchronization of dubbed dialog.

It may be desirable to extract two or more different types of feature vectors over the same sampling period. Generally, extracting two or more different types of feature vectors will enable a smaller number of feature vector values to be extracted for each type of feature vector (i.e., enabling a shorter sampling period) and still enable an accurate match of the extracted feature vectors to the previously extracted feature vectors (again, as described below). For example, it may be desirable to extract values for brightness, volume, and frequency at the same intervals over the same sampling period.

Generally, the type and number of feature vectors, the length of the sampling period, and the sampling interval should be selected such that an accurate match of the extracted feature vectors to the previously extracted feature vectors (again, as described below) is likely to be obtained.

The entity which extracts the feature vectors will typically record the time, according to the entity's internal clock, at which the feature vectors were extracted. This recorded time will typically be one component used to set the start time for the secondary media content, as discussed below.

The feature vectors extracted while the primary media content is being presented (“newly extracted feature vectors”) may then be compared to feature vectors that were previously extracted from the primary media content (“previously extracted feature vectors”). See block 44. The previously extracted feature vectors would typically have been extracted from the primary media content well in advance of the synchronization operation, possibly by the provider of the secondary media content, to enable secondary media content to be synchronized to the primary media content. The previously extracted feature vectors would typically be extracted from the entire length of the primary media content, at predefined intervals (typically at the same intervals as defined in regards to block 42 above). As each feature vector is extracted, a timestamp is associated with each extracted feature vector. Each timestamp corresponds to the temporal location of the portion of the primary media content from which the feature vector is extracted (i.e., the time from the beginning of the primary media content to the extraction of the feature vector).

If two or more different types of feature vectors are to be extracted as the primary media content is presented, as discussed above, it would be advantageous to generate a set of previously extracted feature vectors for the same two or more feature vector types in order to enable comparison and matching of the different types.

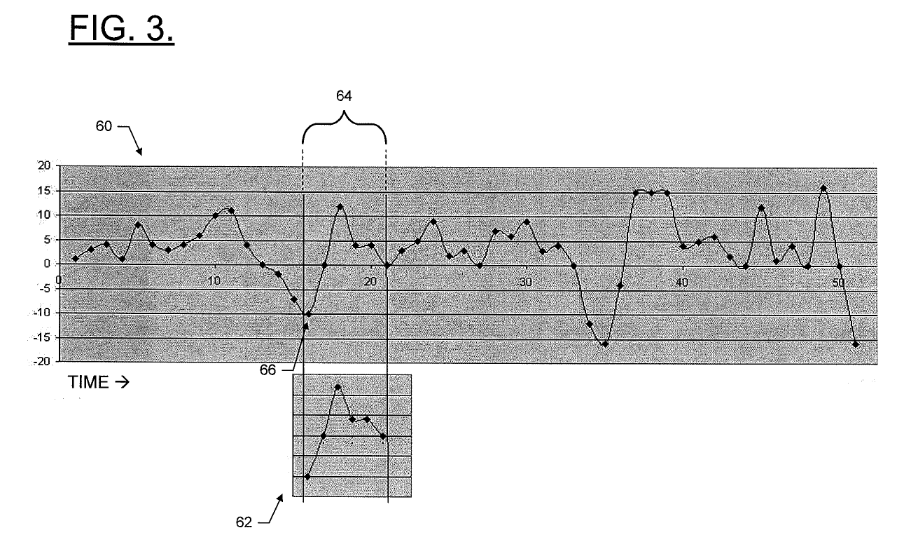

Referring now to FIG. 3, graph 60 is a graphical representation of previously extracted feature vector values of one type of feature vector that have been extracted from a 50 second segment of a primary media content. It should be appreciated that previously extracted feature vectors would not typically be stored in such a graphical format, but rather as numeric values or text in a table in a data file. Table 1 illustrates a format of a table for storing previously extracted feature vector values for three different types of feature vectors, extracted at a 50 millisecond extraction interval, in accordance with an exemplary embodiment of the invention.

TABLE 1

| | Value of | Value of | Value of |
|---|---|---|---|
| Timestamp | Feature Vector | Feature Vector | Feature Vector |
| (milliseconds) | Type 1 | Type 2 | Type 3 |
| 50 | | | |
| 100 | | | |
| 150 | | | |
| 200 | | | |
| 250 | | | |
| 300 | | | |
| 350 | | | |
| 400 | | | |
| 450 | | | |
| 500 | | | |
| . | | | |
| . | | | |
| . | | | |

For a two hour movie, such a table would typically contain approximately 432,000 previously extracted feature vector values (20 values extracted per second ×3600 seconds per hour ×2 hours ×3 feature vector types). Because the previously extracted feature vector values are stored as either numeric values or text in a table, the memory required to store the data is reduced.

The values of the newly extracted feature vectors are compared to the previously extracted feature vector values to identify a matching grouping of the same number of adjacent previously extracted feature vector values. FIG. 3 graphically illustrates the comparison of newly extracted feature vector values 62 to the previously extracted feature vector values 60. Again, this comparison would not be typically be performed using graphical information, but rather numeric values or text representing the newly extracted feature vector values would be compared to all of the previously extracted feature vector values for the primary media content. In the example illustrated in FIG. 3, the newly extracted feature vector values are −10, 0, +12, +4, +4, and 0. A matching grouping is identified at time period 64 of the previously extracted feature vectors. It should be appreciated that the newly extracted feature vector values will typically not match exactly to any of the previously extracted feature vector values, due to many factors such as device differences and degradation of the media content during transmission. As such, it is typically not necessary for the newly extracted feature vector values to exactly match the previously extracted feature vector values. An acceptable margin of error may be predefined such that a match will be determined if the difference between each newly extracted feature vector value and a corresponding previously extracted feature vector value is within the margin of error. For example, for the newly extracted feature vector values illustrated in FIG. 3, if the margin of error is predefined to be +/−0.2, a match will be determined if a grouping of previously extracted feature vector values of +9.8 to +10.2, −0.2 to +0.2, +11.8 to +12.2, +3.8 to +4.2, +3.8 to +4.2, and −0.2 to +0.2 is identified. It should be appreciated that the acceptable margin of error may be expressed as a percentage instead of a numerical value.

In one embodiment, the newly extracted feature vector values may be compared to the previously extracted feature vector values for the entire primary media content, rather than stopping the comparison as soon as a first match is identified, as it is possible that more than one match may be identified. If more than one match is identified, it would be difficult to know which timestamp to use as the start time of the secondary media content. Thus, if more than one match is identified, the newly extracted feature vector values will typically be discarded and a new set of feature vectors may be extracted from the presentation of the primary media content (i.e., begin again at block 42). In an alternative exemplary embodiment, if more than one match is identified, the closest of the multiple matches may be determined and used. The closest match may be determined, for example, by summing the absolute values of the differences between each newly extracted feature vector value and a corresponding previously extracted feature vector value within each matching set, and using the set having the lowest sum.

If more than one type of feature vectors has been extracted, the newly extracted feature vector values for each type is separately compared to the previously extracted feature vector values of the corresponding type in order to identify one interval of time in which the all of the newly extracted values of each type match all of the corresponding previously extracted values of the corresponding type. Each different type of feature vector may have a different acceptable margin of error.

Once a match has been identified between the newly extracted feature vector values and the previously extracted feature vector values, the timestamp of the location of the matching previously extracted feature vector values is obtained. See block 46 of FIG. 2. As the matching previously extracted feature vector values would typically span a time period (e.g., a two second sampling period), the timestamp that is obtained would typically correspond to the temporally-first value within the grouping of matching values. For example, in the example illustrated in FIG. 3, the timestamp for value 66 would be obtained. Similarly, when the entity which extracts the feature vectors records the extraction time, as discussed above, the entity will typically record the extraction time for the first feature vector value.

The obtained timestamp of the matching feature vector values indicates the point in time within the primary media content that the feature vectors were extracted. If there were no delay involved in comparing the extracted feature vectors and determining the timestamp, then the start time for the presentation of the secondary media content could simply be set to be equal to the timestamp, thereby synchronizing the secondary media content to the primary media content. However, as there generally will be some delay involved in comparing the extracted feature vectors and determining the timestamp, then the start time for the presentation of the secondary media content should be adjusted based on this delay. To determine this adjustment, the elapsed time required to compare the extracted feature vectors and determine the timestamp should be determined. See block 48. The elapsed time may be calculated by determining the current time immediately prior to setting the start time and subtracting the recorded extraction time from the current time. This difference is the elapsed time and may be added to the obtained timestamp to determine the start time for the secondary media content. See block 50. Devices capable of presenting media content are commonly able to begin the presentation of media content at any desired start time. The presentation of the secondary media content may therefore be started at the determined start time, such that the presentation of the secondary media content is synchronized to the presentation of the primary media content. See block 52. In one exemplary embodiment, the media device could be in communication (via any suitable network or communication method, whether wireline or wireless, such as Bluetooth, ultra wideband (UWB), universal plug and play (UPnP), or wireless local area network (WLAN)) with one or more other devices that do not have the capability to perform the steps of embodiments of the invention. In such an embodiment, the media device may transmit one or more of the extracted feature vector data, the determined time stamp data, and/or the start point data, such that the other device(s) may begin presentation of a secondary media content that is synchronized with the primary media content.

As discussed above, FIG. 2 generally illustrates actions that may occur during the operation of synchronizing media content, although the entity in which these actions occur may vary in accordance with different embodiments of the invention. In one exemplary embodiment, the described actions may occur entirely in the media device 10. In such an embodiment, the primary media content and the secondary media content would be stored in memory 14 in the media device. Additionally, a data file containing the previously extracted feature vectors for the primary media content would be stored in memory in the media device. The primary media content and the secondary media content may then be accessed from memory, and the primary media content may be presented to the user, such as via display element 16 and speaker 18. As the primary media content is presented, feature vectors are extracted from the primary media content and the extraction time is noted according to the internal clock of the media device. The processing element 12 may then access the previously extracted feature vectors from memory, compare the extracted feature vectors to the previously extracted feature vectors, and determine the timestamp of the matching previously extracted feature vectors. The processing element may then determine the elapsed time and add the elapsed time to the timestamp to set the start time for the secondary media content. The processing element 12 may then begin presenting the secondary media content at the determined start time, thereby causing the presentation of the secondary media content to be synchronized with the presentation of the primary media content.

In another exemplary embodiment, the described actions may occur entirely in the media server 24. In such an embodiment, the primary media content and the secondary media content would be stored in memory 28 in the media server. Additionally, a data file containing the previously extracted feature vectors for the primary media content would be stored in memory in the media server. The primary media content and the secondary media content may then be accessed from memory, and the primary media content may be streamed from the media server to the media device via network 32. As the streamed primary media content is received by the media device it is presented to the user, such as via display element 16 and speaker 18. As the primary media content is streamed from the media server, feature vectors are extracted from the primary media content and the extraction time is noted according to the internal clock of the media server. The processing element 26 may then access the previously extracted feature vectors from memory, compare the extracted feature vectors to the previously extracted feature vectors, and determine the timestamp of the matching previously extracted feature vectors. The processing element 26 may then determine the elapsed time and add the elapsed time to the timestamp to set the start time for the secondary media content. The processing element 26 may then begin streaming the secondary media content to the media device, beginning at the determined start time. Thus, the streaming of the secondary media content is synchronized with the streaming of the primary media content, thereby enabling the synchronized presentation of the primary media content and the secondary media content on the media device.

In another exemplary embodiment, the described actions may occur partly in the media device 10 and partly in the media server 24. In one such embodiment, the primary media content and the secondary media content would be stored in memory 14 in the media device. However, the data file containing the previously extracted feature vectors for the primary media content would be stored in memory in the media server. The primary media content and the secondary media content may then be accessed from memory in the media device, and the primary media content may be presented to the user, such as via display element 16 and speaker 18. As the primary media content is presented, feature vectors are extracted from the primary media content by the processing element of the media device, and the extraction time is noted according to the internal clock of the media device. The extracted feature vectors are then transmitted from the media device to the media server. The processing element 26 of the media server may then access the previously extracted feature vectors from memory, compare the extracted feature vectors to the previously extracted feature vectors, and determine the timestamp of the matching previously extracted feature vectors. The timestamp is then transmitted from the media server to the media device. The processing element 12 of the media device may then determine the elapsed time and add the elapsed time to the timestamp to set the start time for the secondary media content. The processing element 12 may then begin presenting the secondary media content at the determined start time, thereby causing the presentation of the secondary media content to be synchronized with the presentation of the primary media content.

The immediately preceding scenario illustrates a typical embodiment that may be used when the network connection between the media device and the media server is a low latency (i.e., fast) connection. If the network connection between the media device and the media server is a high latency (i.e., slow) connection, a modified embodiment may be used. In the modified embodiment, the media server typically evaluates the latency of the network using any suitable method (e.g., “pinging” the media device). After the media server receives and compares the extracted feature vectors and determines the timestamp, the media server then selects a second set of feature vector values from the previously extracted feature vector values. The second set of feature vector values would be selected from a later position in the primary media content, such that the time difference between the matching set of feature vector values and the second set of feature vector values is greater than the time it would take for a signal to travel across the network from the media device to the media server and back to the media device.

The second set of feature vector values, along with the timestamp corresponding to the second set, is transmitted from the media server to the media device. After the media device receives the second set of feature vector values, the media device continuously extracts feature vectors from the primary media content and compares these continuously extracted feature vector values to the second set of feature vector values. When the media device locates a match for the second set, the media device then uses the timestamp of the second set to set the start time for the secondary media content.

The method for synchronizing the presentation of media content may be embodied by a computer program product. The computer program product includes a computer-readable storage medium, such as the non-volatile storage medium, and computer-readable program code portions, such as a series of computer instructions, embodied in the computer-readable storage medium. Typically, the computer program is stored by a memory device, such as memory 14 or memory 28, and executed by an associated processing unit, such as processing element 12 or processing element 26.

In this regard, FIG. 2 is a flowchart of methods and program products according to the invention. It will be understood that each step of the flowchart, and combinations of steps in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will also be understood that each step of the flowchart, and combinations of steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus for synchronizing the presentation of media content, the apparatus comprising:
a processing element configured to extract a feature vector from a primary media content as the primary media content is presented; the processing element further configured to compare the extracted feature vector to a plurality of stored feature vectors in the storage element, the stored feature vectors previously extracted from the primary media content, each of the stored feature vectors having a respective timestamp corresponding to a temporal location of the stored feature vector within the primary media content; the processing element further configured to determine which of the stored feature vectors matches the extracted feature vector; and the processing element further configured to set a start time for a secondary media content based on the timestamp of the stored feature vector that matches the extracted feature vector.

2. The apparatus of claim 1, wherein the processing element is further configured to begin a presentation of the secondary media content at the start time.

3. The apparatus of claim 1, wherein the processing element is further configured to determine a first time at which the feature vector was extracted and determine a second time at which the start time is to be set; and wherein the processing element sets the start time further based on a difference between the first time and the second time.

4. The apparatus of claim 1, wherein the processing element is further configured to extract a plurality of feature vectors from the primary media content as the primary media content is presented, each of the feature vectors extracted a predefined period of time after the preceding feature vector was extracted, wherein the processing element is further configured to compare the extracted plurality of feature vectors to the plurality of stored feature vectors and determine which of the stored feature vectors match the plurality of extracted feature vectors, and wherein the processing element sets the start time based on the timestamp of the stored feature vector that matches the temporally-first extracted feature vector.

5. The apparatus of claim 1, wherein the extracted feature vector is a first feature vector of a first type, wherein the plurality of stored feature vectors is a first plurality of stored feature vectors of the first type, and wherein the processing element is further configured to extract a second feature vector of a second type from the primary media content as the primary media content is presented, wherein the processing element is further configured to compare the second extracted feature vector to a second plurality of stored feature vectors of the second type, the stored second feature vectors previously extracted from the primary media content, each of the stored second feature vectors having a respective timestamp corresponding to a temporal location of the stored feature vector within the primary media content, and wherein the processing element is further configured to determine which of the stored second feature vectors matches the extracted second feature vector and has the same timestamp as the stored first feature vector that matches the extracted first feature vector.

6. The apparatus of claim 1, embodied in a media player.

7. The apparatus of claim 6, wherein the primary media content and the secondary media content are stored in a storage element of the media player.

8. The apparatus of claim 6, wherein the processing element is configured to capture the primary media content via at least one of a camera or a microphone as the primary media content is presented.

9. The apparatus of claim 1, embodied in a media server.

10. The apparatus of claim 9, wherein the primary media content and the secondary media content are streamed across a network from the media server to a media player.

11. An apparatus for synchronizing the presentation of media content, the apparatus comprising:
a processing element configured to extract a feature vector from a primary media content as the primary media content is presented, the processing element further configured to provide the extracted feature vector for transmission to a media server configured to compare the extracted feature vector to a plurality of stored feature vectors and determine which of the stored feature vectors matches the extracted feature vector, the stored feature vectors previously extracted from the primary media content, each of the stored feature vectors having a respective timestamp corresponding to a temporal location of the stored feature vector within the primary media content;
the processing element further configured to receive a timestamp of the stored feature vector that matches the extracted feature vector from the media server; the processing element further configured to set a start time for a secondary media content based on the received timestamp.

12. The apparatus of claim 11 wherein the processing element is further configured to begin a presentation of the secondary media content at the start time.

13. The apparatus of claim 11, wherein the processing element is further configured to determine a first time at which the feature vector was extracted and determine a second time at which the start time is to be set; and wherein the processing element sets the start time further based on a difference between the first time and the second time.

14. The apparatus of claim 11, wherein the processing element is further configured to extract a plurality of feature vectors from the primary media content as the primary media content is presented, each of the feature vectors extracted a predefined period of time after the preceding feature vector was extracted, wherein the processing element is further configured to transmit the plurality of feature vectors to a media server configured to compare the extracted plurality of feature vectors to the plurality of stored feature vectors and determine which of the stored feature vectors match the plurality of extracted feature vectors,
wherein the processing element is further configured to receive a timestamp of the stored feature vector that matches the temporally-first extracted feature vector from the media server; and wherein the processing element sets the start time based on the received timestamp.

15. The apparatus of claim 11, wherein the extracted feature vector is a first feature vector of a first type, wherein the plurality of stored feature vectors is a first plurality of stored feature vectors of the first type, and wherein the processing element is further configured to extract a second feature vector of a second type from the primary media content as the primary media content is presented,
wherein the processing element is further configured to transmit the second feature vector of a second type to a media server configured to compare the second extracted feature vector to a second plurality of stored feature vectors of the second type, the stored second feature vectors previously extracted from the primary media content, each of the stored second feature vectors having a respective timestamp corresponding to a temporal location of the stored feature vector within the primary media content, and
wherein the processing element is further configured to receive a timestamp of the stored second feature vectors that matches the extracted second feature vector and of the stored first feature vector that matches the extracted first feature vector.

16. The apparatus of claim 11, embodied in a media player.

17. The apparatus of claim 16, wherein the primary media content and the secondary media content are stored in a storage element of the media player.

18. The apparatus of claim 16, wherein the processing element is configured to capture the primary media content via at least one of a camera or a microphone as the primary media content is presented.

19. A system for synchronizing the presentation of media content, the system comprising:
a media server; and
a media player configured to extract a feature vector from a primary media content as the primary media content is presented and transmitting the extracted feature vector to the media server;
wherein the media server is configured to compare the extracted feature vector to a plurality of stored feature vectors, the stored feature vectors previously extracted from the primary media content, each of the stored feature vectors having a respective timestamp corresponding to a temporal location of the stored feature vector within the primary media content, the second media device further configured to determine which of the stored feature vectors matches the extracted feature vector, wherein the media server is further configured to transmit the timestamp of the stored feature vector that matches the extracted feature vector to the media player; and
wherein the media player is further configured to set a start time for a secondary media content based on the timestamp of the stored feature vector that matches the extracted feature vector.

20. The system of claim 19, wherein the media player is further configured to begin a presentation of the secondary media content at the start time.

21. The system of claim 19, wherein the media player is further configured to determine a first time at which the feature vector was extracted and determine a second time at which the start time is to be set; and wherein the media player sets the start time further based on a difference between the first time and the second.

22. The system of claim 19, wherein the media player is further configured to extract a plurality of feature vectors from the primary media content as the primary media content is presented and transmitting the plurality of feature vectors to the media server, each of the feature vectors extracted a predefined period of time after the preceding feature vector was extracted, wherein the media server is further configured to compare the extracted plurality of feature vectors to the plurality of stored feature vectors and determine which of the stored feature vectors match the plurality of extracted feature vectors, and wherein the media player sets the start time based on the timestamp of the stored feature vector that matches the temporally-first extracted feature vector.

23. The system of claim 19, wherein the extracted feature vector is a first feature vector of a first type, wherein the plurality of stored feature vectors is a first plurality of stored feature vectors of the first type, and wherein the media player is further configured to extract a second feature vector of a second type from the primary media content as the primary media content is presented and transmitting the second feature vector to the media server, wherein the media server is further configured to compare the second extracted feature vector to a second plurality of stored feature vectors of the second type, the stored second feature vectors previously extracted from the primary media content, each of the stored second feature vectors having a respective timestamp corresponding to a temporal location of the stored feature vector within the primary media content, and wherein the media server is further configured to determine which of the stored second feature vectors matches the extracted second feature vector and has the same timestamp as the stored first feature vector that matches the extracted first feature vector.

24. The system of claim 19, wherein the primary media content and the secondary media content are stored on the media player.

25. The system of claim 19, wherein the secondary media content is stored on the media player and the primary media content is streamed across a network from the media server to the media player.

26. A method for synchronizing the presentation of media content, the method comprising:
extracting a feature vector from a primary media content as the primary media content is presented;
comparing the extracted feature vector to a plurality of stored feature vectors, the stored feature vectors previously extracted from the primary media content, each of the stored feature vectors having a respective timestamp corresponding to a temporal location of the stored feature vector within the primary media content;
determining which of the stored feature vectors matches the extracted feature vector; and
determining a timestamp of the stored feature vector that matches the extracted feature vector, from which a start time for a secondary media content is determined.

27. The method of claim 26, further comprising:
beginning a presentation of the secondary media content at the start time.

28. The method of claim 26, further comprising:
determining a first time at which the feature vector was extracted; and
determining a second time at which the start time is to be set;
wherein the start time is determined further based on a difference between the first time and the second time.

29. The method of claim 26, further comprising:
extracting a plurality of feature vectors from the primary media content as the primary media content is presented, each of the feature vectors extracted a predefined period of time after the preceding feature vector was extracted;
comparing the extracted plurality of feature vectors to the plurality of stored feature vectors; and
determining which of the stored feature vectors match the plurality of extracted feature vectors;
wherein setting the start time is based on the timestamp of the stored feature vector that matches the temporally-first extracted feature vector.

30. The method of claim 26, wherein the extracted feature vector is a first feature vector of a first type, and wherein the plurality of stored feature vectors is a first plurality of stored feature vectors of the first type, and wherein the method further comprises:
extracting a second feature vector of a second type from the primary media content as the primary media content is presented;
comparing the second extracted feature vector to a second plurality of stored feature vectors of the second type, the stored second feature vectors previously extracted from the primary media content, each of the stored second feature vectors having a respective timestamp corresponding to a temporal location of the stored feature vector within the primary media content; and
determining which of the stored second feature vectors matches the extracted second feature vector and has the same timestamp as the stored first feature vector that matches the extracted first feature vector.

31. A computer program product for synchronizing the presentation of media content, the computer program product comprising at least one computer-readable storage medium having computer-readable program code portions stored therein, the computer-readable program code portions comprising:
a first executable portion configured to extract a feature vector from a primary media content as the primary media content is presented;
a second executable portion configured to compare the extracted feature vector to a plurality of stored feature vectors, the stored feature vectors previously extracted from the primary media content, each of the stored feature vectors having a respective timestamp corresponding to a temporal location of the stored feature vector within the primary media content;
a third executable portion configured to determine which of the stored feature vectors matches the extracted feature vector; and
a fourth executable portion configured to determine a timestamp of the stored feature vector that matches the extracted feature vector, from which a start time for a secondary media content is determined.

32. The computer program product of claim 31, further comprising:
a fifth executable portion configured to begin a presentation of the secondary media content at the start time.

33. The computer program product of claim 31, further comprising:
a fifth executable portion configured to determine a first time at which the feature vector was extracted; and
a sixth executable portion configured to determine a second time at which the start time is to be set;
wherein the fourth executable portion is configured to determine the start time further based on a difference between the first time and the second time.

34. The computer program product of claim 31, further comprising:
a fifth executable portion configured to extract a plurality of feature vectors from the primary media content as the primary media content is presented, each of the feature vectors extracted a predefined period of time after the preceding feature vector was extracted;
a sixth executable portion configured to compare the extracted plurality of feature vectors to the plurality of stored feature vectors; and
a seventh executable portion configured to determine which of the stored feature vectors match the plurality of extracted feature vectors;
wherein the fourth executable portion is configured to set the start time based on the timestamp of the stored feature vector that matches the temporally-first extracted feature vector.

35. The computer program product of claim 31, wherein the extracted feature vector is a first feature vector of a first type, and wherein the plurality of stored feature vectors is a first plurality of stored feature vectors of the first type, and wherein the computer program product further comprises:
a fifth executable portion configured to extract a second feature vector of a second type from the primary media content as the primary media content is presented;
a sixth executable portion configured to compare the second extracted feature vector to a second plurality of stored feature vectors of the second type, the stored second feature vectors previously extracted from the primary media content, each of the stored second feature vectors having a respective timestamp corresponding to a temporal location of the stored feature vector within the primary media content; and
a seventh executable portion configured to determine which of the stored second feature vectors matches the extracted second feature vector and has the same timestamp as the stored first feature vector that matches the extracted first feature vector.
